(19) United States
(12) Patent Application Publication
(10) Pub. No.: US 2022/0153283 A1
(43) Pub. Date: May 19, 2022

(54) ENHANCED COMPONENT DIMENSIONING

(71) Applicant: Ford Global Technologies, LLC, Dearborn, MI (US)

(72) Inventors: David Alfred Ostrowski, Northville, MI (US); Christopher Leon Jones, Detroit, MI (US); Jacob Martin Povirk, Franklin, MI (US); Ashish Kumar Naidu, Canton, MI (US); Andrew Block, Plymouth, MI (US)

(73) Assignee: Ford Global Technologies, LLC, Dearborn, MI (US)

(21) Appl. No.: 17/097,288

(22) Filed: Nov. 13, 2020

(51) Int. Cl. B60W 50/00; B60W 50/14

(52) U.S. Cl. CPC B60W 50/0098; B60W 50/14; B60W 2400/00; B60W 2552/15; B60W 2756/00; B60W 2554/406; B60W 2555/20; B60W 2050/146; B60W 2552/30

(57) ABSTRACT

Vehicle environment data about operation of a plurality of vehicles and vehicle component data for a vehicle component is input into a machine learning program to obtain a transfer function that correlates vehicle environment data to vehicle component data within a specified range of vehicle component parameters. A first event is identified by determining that a datum in the vehicle component data is outside the specified range. A predictive damage model of a vehicle component is updated based on the first event. A virtual parameter of a component model is adjusted based on output from the predictive damage model.

### BACKGROUND

Vehicles include a plurality of components. The components are each specified to have specific tolerances and for specific operation of the vehicle. For example, a steering gear transmits rotation of a steering column to translation of a steering rack. Rotation of the steering gear induces stresses to the steering gear. Components are typically designed to absorb stresses during operation.

### BRIEF DESCRIPTION OF THE DRAWINGS

FIG. 1 is a block diagram for an example system for collecting vehicle component data.

FIG. 2A is a first part of a flowchart of an example process for or designing a vehicle component.

FIG. 2B is a second part of the flowchart of FIG. 2A.

### DETAILED DESCRIPTION

A system includes a computer including a processor and a memory, the memory storing instructions executable by the processor to input vehicle environment data about operation of a plurality of vehicles and vehicle component data for a vehicle component into a machine learning program to obtain a transfer function that correlates vehicle environment data to vehicle component data within a specified range of vehicle component parameters. The instructions further include instructions to identify a first event based on determining that a datum in the vehicle component data is outside the specified range. The instructions further include instructions to update a predictive damage model of a vehicle component based on the first event. The instructions further include instructions to adjust a virtual parameter of a component model based on output from the predictive damage model.

The instructions can further include instructions to, upon determining a number of first events for the plurality of vehicles equals a threshold, input the first event and the datum for each first event to a second machine learning program. The instructions can further include instructions to output from the second machine learning program an event transfer function that correlates the first event to the data of the first events. The instructions can further include instructions to determine a durability transfer function by combining the transfer function and the event transfer function. The instructions can further include instructions to update the predictive damage model based on the durability transfer function.

The instructions can further include instructions to update the specified range to include the datum for each first event.

The instructions can further include instructions to, upon determining a number of first events is below a threshold, request a user input specifying a presence or absence of the first event.

The instructions can further include instructions to, upon receiving the user input specifying the presence of the first event, update the specified range to include the datum.

The instructions can further include instructions to generate an event envelope including the datum of the vehicle component data and provide the event envelope to a user computer.

The instructions can further include instructions to, upon a number of first events is above a threshold, update the specified range to include the datum.

The instructions can further include instructions to decrease the specified range based on a number of first events being less than or equal to a lower limit.

The instructions can further include instructions to, upon adjusting the virtual parameter of the component model, update a predictive damage model of an adjusted component model based on the first event and adjust a virtual component of the adjusted component model based on the output of the predictive damage model of the adjusted component model.

The instructions can further include instructions to update successive predictive damage models of successive adjusted component models based on the first event until an optimization criterion for the virtual parameter is satisfied.

The instructions can further include instructions to input the adjusted component model into a vehicle dynamics model that outputs performance data for the virtual component constructed in accordance with the adjusted component model.

The vehicle dynamics model can include a model of a plurality of road segments and the performance data includes data of the virtual component operating in each segment.

The vehicle dynamics model can include a model of a plurality of environmental conditions, and the performance data includes data of the virtual component operating in the plurality of environmental conditions.

The instructions can further include instructions to, upon detecting a diagnostic trouble code associated with the vehicle component, correlate the first event to the diagnostic trouble code, and update the specified range to include the datum.

The instructions can further include instructions to, upon determining a number of first events is zero after a predetermined time, increase the specified range.

The output of the predictive damage model can generate data indicating stresses the virtual component.

The vehicle environment data includes road data, weather data, traffic density data, vehicle performance data, and user input data.

A method includes inputting vehicle environment data about operation of a plurality of vehicles and vehicle component data for a vehicle component into a machine learning program to obtain a transfer function that correlates vehicle environment data to vehicle component data within a specified range of vehicle component parameters. The method further includes identifying a first event based on determining that a datum in the vehicle component data is outside the specified range. The method further includes updating a predictive damage model of a vehicle component based on the first event. The method further includes adjusting a virtual parameter of a component model based on output from the predictive damage model.

The method can further include, upon determining a number of first events for the plurality of vehicles equals a threshold, inputting the first event and the datum for each first event to a second machine learning program. The method can further include outputting from the second machine learning program an event transfer function that correlates the first event to the data of the first events. The method can further include determining a durability transfer function by combining the transfer function and the event transfer function. The method can further include updating the predictive damage model based on the durability transfer function.

The method can further include, upon adjusting the virtual parameter of the component model, updating a predictive damage model of an adjusted component model based on the first event and adjusting a virtual component of the adjusted component model based on the output of the predictive damage model of the adjusted component model.

Further disclosed herein is a computing device programmed to execute any of the above method steps. Yet further disclosed herein is a computer program product, including a computer readable medium storing instructions executable by a computer processor, to execute an of the above method steps.

A server can collect vehicle component data and vehicle environment data during vehicle operation from a plurality of vehicles. Typically, the server collects vehicle component data within a specified range of vehicle component parameters. The specified range may be determined based on predicted operating conditions of the vehicle component, and thus may not capture all actual operating conditions for the vehicle component. Advantageously, the server can identify events based on data outside a specified or expected range of operating parameters. The server can then update the specified range based on the events, which allows the server to collect data for the actual operating conditions of the vehicle component.

The server can then test a component model of a virtual component with a transfer function that correlates environment data to vehicle component data within the specified range, improving specifications that can be provided for a component, i.e., a size and/or shape can be better specified. That is, by adjusting the model according to stresses and strains experienced according to collected component data, the component can be designed to meet one or more optimization criteria, e.g., cost, weight, fatigue limit, etc. Inputting the transfer function to a predictive damage model for the component model provides a more accurate representation of the stresses that would be applied to the vehicle component during operation and allows the component model to be adjusted to account for those stresses.

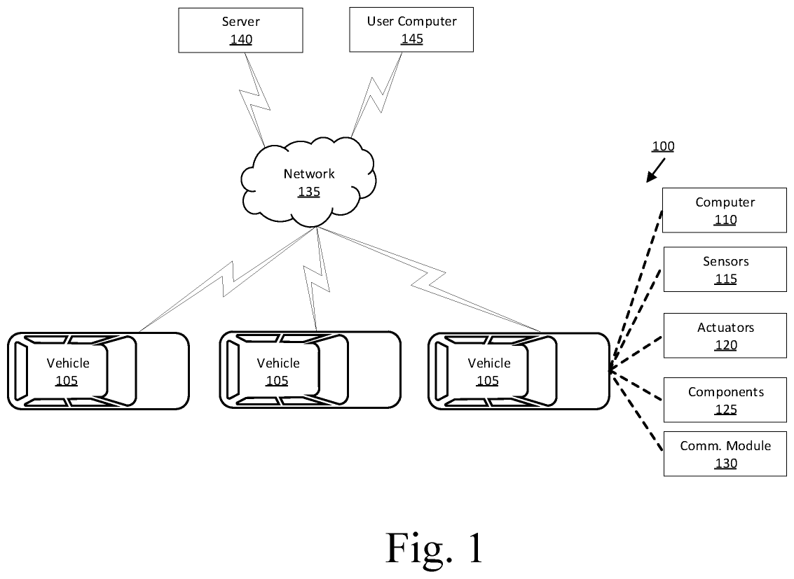

With reference to FIG. 1, an example system 100 for collecting vehicle component data includes a plurality of vehicles 105 and a server 140. A vehicle computer 110 in each vehicle 105 receives data from sensors 115. The vehicle computer 110 provides the data to the server 140. The server 140 is programmed to input vehicle environment data about operation of the plurality of vehicles 105 and vehicle component data for a vehicle component 125 to a machine learning program to obtain a transfer function that correlates vehicle environment data to vehicle component data within a specified range of vehicle component parameters. The server 140 is further programmed to identify a first event based on determining that a datum in the vehicle component data is outside the specified range. The server 140 is further programmed to update a predictive damage model of a vehicle component based on the first event. The server 140 is further programmed to adjust a virtual parameter of a component model based on output from the predictive damage model.

Each vehicle 105 includes a vehicle computer 110, sensors 115, actuators 120 to actuate various vehicle components 125, and a vehicle communications module 130. The communications module 130 allows the vehicle computer 110 to communicate with a server 140 and/or other vehicles, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above and/or may include a dedicated electronic circuit including an ASIC that is manufactured for a particular operation, e.g., an ASIC for processing sensor data and/or communicating the sensor data. In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the vehicle computer 110.

The vehicle computer 110 may operate the vehicle 105 in an autonomous, a semi-autonomous mode, or a non-autonomous (or manual) mode. For purposes of this disclosure, an autonomous mode is defined as one in which each of vehicle 105 propulsion, braking, and steering are controlled by the vehicle computer 110; in a semi-autonomous mode the vehicle computer 110 controls one or two of vehicle 105 propulsion, braking, and steering; in a non-autonomous mode a human operator controls each of vehicle 105 propulsion, braking, and steering.

The vehicle computer 110 may include programming to operate one or more of vehicle 105 brakes, propulsion (e.g., control of acceleration in the vehicle 105 by controlling one or more of an internal combustion engine, electric motor, hybrid engine, etc.), steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to, e.g., via a vehicle communications network such as a communications bus as described further below, more than one processor, e.g., included in electronic controller units (ECUs) or the like included in the vehicle 105 for monitoring and/or controlling various vehicle components 125, e.g., a transmission controller, a brake controller, a steering controller, etc. The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices, e.g., sensors 115, an actuator 120, ECUs, etc. Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles, etc., relative to the location of the vehicle 105. The sensors 115 may further alternatively or additionally, for example, include camera sensor(s) 115, e.g. front view, side view, etc., providing images from an area surrounding the vehicle 105. In the context of this disclosure, an object is a physical, i.e., material, item that has mass and that can be represented by physical phenomena (e.g., light or other electromagnetic waves, or sound, etc.) detectable by sensors 115. Thus, the vehicle 105, as well as other items including as discussed below, fall within the definition of “object” herein.

The vehicle computer 110 is programmed to receive data from one or more sensors 115 substantially continuously, periodically, and/or when instructed by a server 140, etc. The data may, for example, include a location of the vehicle 105. Location data specifies a point or points on a ground surface and may be in a known form, e.g., geo-coordinates such as latitude and longitude coordinates obtained via a navigation system, as is known, that uses the Global Positioning System (GPS). Additionally, or alternatively, the data can include a location of an object, e.g., a vehicle, a sign, a tree, etc., relative to the vehicle 105. As one example, the data may be image data of the environment around the vehicle 105. In such an example, the image data may include one or more objects, e.g., other vehicles, and/or markings, e.g., lane markings, on or along a current road. Image data herein means digital image data, e.g., comprising pixels with intensity and color values, that can be acquired by camera sensors 115. The sensors 115 can be mounted to any suitable location in or on the vehicle 105, e.g., on a vehicle 105 bumper, on a vehicle 105 roof, etc., to collect images of the environment around the vehicle 105.

The vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component 125 (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

In addition, the vehicle computer 110 may be configured for communicating via a vehicle-to-vehicle communication module 130 or interface with devices outside of the vehicle 105, e.g., through a vehicle-to-vehicle (V2V) or vehicle-to-infrastructure (V2X) wireless communications (cellular and/or DSRC., etc.) to another vehicle, and/or to a server 140 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), and/or wide area networks (WAN), including the Internet, providing data communication services.

The network 135 represents one or more mechanisms by which a vehicle computer 110 may communicate with remote computing devices, e.g., the server 140, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

While operating a vehicle 105 along a road, a vehicle computer 110 may be programmed to receive vehicle component data for one or more vehicle components 125. For example, the vehicle computer 110 can receive sensor 115 data from one or more sensors 115 associated with the respective vehicle component 125. Vehicle component data includes vehicle component parameters of the vehicle component 125. In this context, a “component parameter” is a measurable quantity of operation of a vehicle component 125. Component parameters describe physical phenomena associated with operating components. Example component parameters include, e.g., a torque, a temperature, an angular velocity, etc. The vehicle computer 110 can then provide the vehicle component data for each vehicle component 125 to the server 140. For example, the vehicle computer 110 can transmit the vehicle component data to the server 140, e.g., via the network 135.

The vehicle component data can also include user input data. The vehicle computer 110 can determine user input data from sensors 115 associated with one or more vehicle components 125. User input data specifies a user input to one or more vehicle components 125. For example, the vehicle computer 110 can detect actuation of a brake component 125 via a brake sensor 115. A brake sensor 115 can be any suitable type of sensor to measure movement of a brake pedal, including how much pressure is applied to the brake pedal. The brake sensor 115 may output a signal representing as much to the vehicle computer 110. As another example, the vehicle computer 110 can receive, from a steering wheel sensor, steering data specifying a steering wheel angle. The steering wheel angle indicates a rotation input to the steering wheel from the user.

Additionally, the vehicle computer 110 may be programmed to obtain vehicle environment data. A road in the present context is an area of ground surface that includes any surface provided for land vehicle travel. A road is defined with boundaries, e.g., by geo-fencing. Vehicle environment data is a subset of data, specifically data providing measurements of phenomena outside a vehicle, i.e., in an environment around the vehicle, that is collected about operation of one or more vehicle 105 subsystems and/or components 125; vehicle environment data includes road data, weather data, traffic density data, and vehicle performance data. The vehicle computer 110 can then provide the vehicle environment data to the server 140. For example, the vehicle computer 110 can transmit the vehicle environment data to the remote server computer 140, e.g., via the network 135.

The vehicle computer 110 may, for example, identify a current road of vehicle 105 operation based on map data. The vehicle computer 110 may receive the map data from the remote server computer 140, e.g., via the network 135. In such an example, the geo-fence specifies a perimeter of the road according to geo-coordinates, e.g., such as are used in the Global Positioning System (GPS) that specify lines defining boundaries, i.e., the perimeter, of the road. The vehicle computer 110 can then determine the vehicle 105 is on the road based on the location data of the vehicle 105 indicating the vehicle 105 is within the geo-fence.

Upon identifying the current road of vehicle 105 operation, the vehicle computer 110 may determine one or more characteristics of the current road, i.e., physical quantities that describe measurements and/or limitations of the road. For example, road characteristics can include a curvature, an inclination, a speed limit, number of lanes, etc. The vehicle computer 110 can, for example, determine the road characteristics based on the map data. The vehicle computer 110 can then determine a type of the current road based on the characteristics of the current road. A type of road is a classification of the road that describes expected vehicle use of the road. Each type of road is further defined by a plurality of predefined characteristics. A road type can be identified by an identifier that describes the road type. Non-limiting examples of types of roads include: highways, freeways, expressways, service drives, side streets, off-ramps, on-ramps. The plurality of predefined characteristics for each type of road may be specified, e.g., by government regulations.

The vehicle computer 110 may determine the weather data for the vehicle 105 location based on sensor 115 data. For example, the vehicle computer 110 can analyze image data, e.g., using image processing techniques, to determine the weather data for the vehicle 105 location. As another example, the vehicle computer 110 can receive data from e.g., a precipitation sensor 115, an ambient temperature sensor 115, a humidity sensor 115, etc., indicating weather data for the vehicle 105 location. As yet another example, the vehicle computer 110 can receive weather data from an external server, e.g., from a weather station. The weather data typically includes conventional measurements, e.g., ambient air temperature, ambient humidity, precipitation information, forecasts, wind speed, etc. That is, the weather data may specify a wind speed and a wind direction in addition to other physical phenomenon in an ambient environment, e.g., an air temperature, an amount of ambient light, a presence or absence of precipitation, a type of precipitation (e.g., snow, rain, etc.), an amount of precipitation (e.g., a volume or depth of precipitation being received per unit of time, e.g., amount of rain per minute or hour), presence or absence of atmospheric occlusions that can affect visibility, e.g., fog, smoke, dust, smog, a level of visibility (e.g., on a scale of 0 to 1, 0 being no visibility and 1 being unoccluded visibility), etc.

The vehicle computer 110 can determine the traffic density of the road based on sensor 115 data, e.g., image data of the environment around the vehicle 105. Traffic density data specifies a traffic density for a road. Traffic density is a number of vehicles per unit distance along a length of a road, e.g., a number of vehicles per kilometer. The vehicle computer 110 can then count the number of vehicles traveling in the same direction as the vehicle 105 along a section of the road, e.g., using image processing techniques, and divide that number by the length of the section of the road. The vehicle computer 110 can determine the length of the section based on fields of view of the sensors 115, e.g., stored in a memory of the vehicle computer 110.

The vehicle computer 110 can determine vehicle performance data based on sensor 115 data. In this context, “performance data” is data providing a quantitative measurement of an output of the vehicle 105. For example, the performance data can include, e.g., a speed of the vehicle 105, an acceleration of the vehicle 105, a heading of the vehicle 105, etc. The vehicle computer 110 can receive speed data from a vehicle speed sensor. A vehicle speed sensor can output a vehicle speed, i.e., a rate of movement of the vehicle, typically in a forward direction, with respect to a ground surface such as a road. For example, one or more wheel speed sensors can be provided as is known to detect a rate of rotation of vehicle wheels, from which a speed of the vehicle can be determined. Alternatively, or additionally, a vehicle speed sensor can detect a rate of rotation of a crankshaft, from which the vehicle speed can be determined. Additionally, the vehicle computer 110 can receive acceleration data from an inertial measurement unit (IMU). An “inertial measurement unit” is a set of sensors 115 that detect linear acceleration and rotational accelerations in a vehicle coordinate system. The IMU sensors 115 can include, e.g., accelerometers, gyroscopes, pressure sensors, magnetometers, etc.

The server 140 can be a conventional computing device, e.g., including one or more processors and one or more memories, programmed to provide operations such as disclosed herein. Further, the server 140 can be accessed via the network 135, e.g., the Internet, a cellular network, and/or or some other wide area network.

Upon receiving the vehicle environment data and the vehicle component data, the server 140 can input the vehicle environment data, the vehicle component data, and a specified range of vehicle component parameters to a first machine learning program that outputs a transfer function. A transfer function is mathematical function that models a system's output for each possible input. The first machine learning program can be a neural network, e.g., a convolutional neural network (CNN). A CNN is a software program that can be implemented on a computing device that can be trained to input the vehicle environment data and the vehicle component data and output a transfer function. A CNN includes a series of layers, with each layer using the previous layer as input. Each layer contains a plurality of neurons that each receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential transfer function and the final output is the transfer function with the highest score.

The transfer function correlates the vehicle environment data to the vehicle component data within the specified range of vehicle component parameters. The specified range is a range defined by minimum and maximum values of vehicle component parameters that have been determined, e.g., by a component manufacturer or vehicle manufacturer, e.g., based on empirical testing, prior field use, etc., to normal vehicle component operation. As explained above, vehicle component parameters are a measurable quantity of operation of a vehicle component 125. The minimum and maximum values can be determined based on empirical testing of vehicle component parameters and specified values at which material fatigue may occur. The specified range may be stored, e.g., in a memory of the server 140.

The server 140 can be programmed to determine a total number of events for a vehicle component (as discussed below, an event is deemed to occur when a parameter is outside its specified range) based on vehicle component data. For example, the server 140 can compare the vehicle component parameters to the specified range. The server 140 can then count each datum that is outside the specified range. That is, upon determining a datum is outside the specified range, the server 140 can increase the total number of events by one. The server 140 can store the total number of events, e.g., in a memory of the server 140.

The server 140 can update the specified range for a component parameter based on the total number of events. For example, upon determining the total number of events is zero for a predetermined time, the server 140 can decrease the specified range. For example, the server 140 can decrease the maximum value (or increase the minimum value) of the vehicle component parameter by a predetermined percentage, e.g., 5%. The predetermined percentage can be determined based on empirical testing of vehicle component parameters and specified values at which material fatigue may occur. The predetermined time may be determined empirically, e.g., by determining an average time of vehicle operation to identify an event. The predetermined time may be stored, e.g., in a memory of the server 140. The server 140 can, for example, initiate a timer upon detecting a vehicle is operating, e.g., by receiving data from the vehicle. The timer can have a duration equal to the predetermined time. The server 140 can stop the timer upon detecting a vehicle is not operating, e.g., by not receiving data from the vehicle.

The server 140 can be programmed to update the specified range based on the total number of events for the vehicle component. For example, the server 140 can compare the total number of events to a lower limit. When the total number of events is greater than or equal to the lower limit, the server 140 can maintain the specified range. When the total number of events is less than the lower limit, the server 140 can decrease the specified range, e.g., by the predetermined percentage. The lower limit can be determined by determining a minimum number of events that satisfy a ratio (e.g., specified by a vehicle and/or component manufacturer) of the number of events to the vehicle component parameters within the specified range. The lower limit can be stored, e.g., in the memory of the server 140. The server 140 can continue to decrease the specified range by the predetermined percentage until the total number of events is greater than or equal to the lower limit.

The server 140 is programmed to identify each event based on each datum of vehicle component data that is outside the specified range. For example, the server 140 can input each datum that is outside the specified range and the vehicle environment data associated with each datum into another machine learning program that outputs an identified event for each datum. The machine learning program can generate a plurality of events based on the data that is outside the specified range.

The machine learning program that outputs the identified events can be a neural network, e.g., a deep neural network, such as a CNN, an R-CNN (Region-based CNN), a Fast R-CNN, and a Faster R-CNN, etc., that includes a cost function. The cost function can include a plurality of weighted variables that can be tuned to minimize a difference between a reference input and a generated output. The machine learning program can output events corresponding to values of the cost function below a predetermined cost threshold. The cost threshold can be determined as a value at which the machine learning program generates an output corresponding to a reference input correctly at a predetermined percentage, e.g., 95% of inputs are correctly identified in generated output. The machine learning program can cluster events according to specific characteristics. For example, the machine learning program can cluster events according to a road attribute, as described below, and then according to a vehicle use attribute.

In this context, an “event” is associated with a set of characteristics about a road that includes road attributes and vehicle use attributes on the road. Additionally, set of characteristics about the road can include user attributes. Roads associated with different events cause different stresses on components 125, which can require adjustments to design of the components 125 to improve life of the component 125.

Each event is associated with specific road attributes. A “road attribute” is a description of physical characteristics of the road and the surrounding area. That is, each road attribute describes characteristics about road and/or the environment around the road that can affect operation of the component 125. For example, each road attribute can describe one or more types of roads, e.g., a highway, an expressway, a city street, etc. Additionally, or alternatively, each road attribute can describe one or more characteristics of the road, e.g., a speed limit, a curvature, a grade, etc. Additionally, or alternatively, each road attribute can include weather data for the road, e.g., an absence or presence of precipitation, a type of precipitation, etc.

Each event is associated with specific vehicle use attributes. A “vehicle use attribute” is a description of vehicle performance on the road. That is, each vehicle use attribute is a quantity, i.e., a value, that specifies how the vehicle operates that can affect operation of the component 125. For example, each vehicle use attribute can describe traffic density of the road. For example, operating the vehicle 105 on a road with a traffic density above a saturation point (i.e., a traffic density beyond which the speed of traffic, i.e., average speed of vehicles at a point on a road, decreases) could include braking the vehicle to a stop and accelerating the vehicle from the stop, which involves operation of components 125 of multiple subsystems, e.g., propulsion, braking, etc. Additionally, or alternatively, each vehicle use attribute can describe vehicle performance, e.g., speed, acceleration, etc. Stopping, turning, and accelerating can increase wear on components 125 associated with various subsystems (e.g., braking, steering, propulsion, etc.)

Additionally, or alternatively, each event can be associated with user attributes. A “user attribute” is a description of user operation of a vehicle 105 on the road. That is, each user attribute specifies how user operation of vehicles 105 can affect operation of the component 125. For example, each user attribute can describe user input, e.g., a torque applied to a steering wheel, a pressure applied to a brake pedal, a pressure applied to an acceleration pedal, etc. User input, e.g., aggressive braking or acceleration, turning at excessive speeds, etc., can further increase wear on components 125 associated with various subsystems (e.g., braking, steering, propulsion, etc.). The server 140 can use data assigned to the events to adjust the design of components 125 associated with the respective subsystems based on road attributes, vehicle use attributes, and/or user attributes.

The server 140 can update the specified range based on a number of identified events. For example, upon determining the total number of events is greater than or equal to the lower limit, the server 140 can compare a number of first events to a first threshold. The first threshold can be determined empirically, e.g., by determining a maximum number of first events above which the server 140 determines the first event represents normal operation of the vehicle component. The first threshold can be stored, e.g., in the memory of the server 140. Upon determining that the number of first events is greater than or equal to the first threshold, the server 140 can update the specified range. For example, the server 140 can increase the specified range, e.g., by decreasing the minimum value and/or increasing the maximum value of the vehicle component parameter, to include the vehicle component data associated with the first event.

Additionally, or alternatively, upon determining the number of first events is less than the first threshold, the server 140 can compare the number of first events to a second threshold. The second threshold can be determined empirically, e.g., by determining a number of events at which the server 140 can identify an event transfer function (as discussed below). The second threshold can be stored, e.g., in the memory of the server 140.

The server 140 can be programmed to determine the number of identified events by counting each identified event. For example, upon identifying a first event, the server 140 can increase the number of first events by one. The server 140 can store the number of each identified event, e.g., in a memory of the server 140.

Upon determining the number of first events is greater than or equal to the second threshold, the server 140 is programmed to determine an event transfer function. An event transfer function correlates the first event to datum for each first event within an event range. The event range is a range defined by minimum and maximum values of data of vehicle component parameters associated with the first event. The server 140 can input the first event and the datum for each first event to a second machine learning program that outputs an event transfer function. The second machine learning program can be substantially similar to the first machine learning program, as discussed above.

Additionally, upon determining the event transfer function, the server 140 can determine a durability transfer function based on the event transfer function and the transfer function. A durability transfer function correlates the vehicle environment data to the vehicle component data within a durability range. For example, the server 140 can combine, e.g., add, the event transfer function and the transfer function:

D(x)=w₁T(x)+w₂E(x) (1)

where D(x) represents the durability transfer function, T(x) represents the transfer function, E(x) represents the event transfer function, and w₁ and w₂ are weights, e.g., between 0 and 1. The weights w₁ and w₂ may be empirically determined by making many observations of actual vehicle component 125 operation and simulated virtual component 125 operation. The server 140 can determine the durability range by combining, e.g., adding, the specified range and the event range. For example, the server 140 can increase the specified range, e.g., by decreasing the minimum value and/or increasing the maximum value of the vehicle component parameter, to include the event range.

Upon determining the number of first events is less than the second threshold, the server 140 can generate an event envelope for each first event. An event envelope is a plot of vehicle environment data and vehicle component data over time. The server 140 inputs vehicle environment data and vehicle component data collected within a time period to the event envelope. The event envelope displays changes in the vehicle environment data and the vehicle component data during the time period. The event envelope is centered, i.e., has an origin at, the first event. That is, the time period extends in equal durations prior to and after a time of the first event. The time period may, for example, be a predetermined time period, e.g., 30 seconds, 2 minutes, 5 minutes, etc. The time period may be stored, e.g., in a memory of the server 140.

The server 140 can be programmed to provide the event envelope to a user computer 145. For example, the server 140 can transmit the event envelope to the user computer 145, e.g., via the network 135. The user computer 145 can then display the event envelope to a user. The user computer 145 can be a conventional computing device, i.e., including one or more processors and one or more memories, programmed to provide operations such as disclosed herein. Further, the user computer 145 can be accessed via the network 135, e.g., the Internet, a cellular network, and/or or some other wide area network.

In a same or different transmission as the event envelope, the server 140 can request a user input specifying an absence or a presence of the first event. The user computer 145 can include a human-machine interface (HMI) that includes user input devices such as knobs, buttons, switches, pedals, levers, touchscreens, and/or microphones, etc. The input devices may include sensors to detect user inputs and provide user input data to the user computer 145. That is, the user computer 145 may be programmed to receive user input from the HMI. The user may provide each user input via the HMI, e.g., by pressing a virtual button on a touchscreen display, by providing voice commands, etc. For example, a touchscreen display included in an HMI may include sensors to detect that a user pressed a virtual button on the touchscreen display to, e.g., specify the presence or absence of the identified event, which input can be received in the user computer 145 and used to determine the selection of the user input. The user computer 145 can then provide the user input to the server 140. For example, the user computer 145 can transmit a response specifying the user input to the server 140, e.g., via the network 135.

The server 140 can, for example, then update the specified range for a component parameter based on the user input specifying a presence of the first event. For example, the server 140 can increase the specified range to include the vehicle component data associated with the first event. Conversely, the server 140 can maintain the specified range based on the user input specifying an absence of the first event.

Additionally, or alternatively, upon determining the number of first events is less than the second threshold, the server 140 can be programmed to update the specified range based on health data for the vehicle component 125. The server 140 can correlate the health data to the first event. For example, the server 140 can compare the health data to the first event. When a vehicle component datum included in the health data matches the vehicle component datum of the first event, the server 140 can correlate the health data to the first event. When vehicle component data included in the health data does not match the vehicle component datum of the first event, the server 140 can determine no correlation between the health data and the first event.

Health data is data that identifies possible faults, or the like, (i.e., a deviation from defined normal operating behavior) in the vehicle component 125. The health data can include a diagnostic trouble code associated with the vehicle component 125. The server 140 can, for example, receive the DTC from the vehicle computer 110. In such an example, the vehicle computer 110 can receive data, e.g., from one or more sensors 115 monitoring the respective vehicle component 125, describing operation of the vehicle component 125. When one or more vehicle component parameters are outside the specified range, the vehicle computer 110 can set a DTC for the vehicle component 125. The vehicle computer 110 can then provide, e.g., transmit via the network 135, the DTC and the vehicle component data to the server 140. The server 140 can then update the specified range to include the vehicle component data associated with the DTC. Additionally, or alternatively, the health data can include warranty data associated with the vehicle component. The server 140 can receive the warranty data, e.g., via the network 135, from one or more computers, such as the user computer 145 or a computer associated with a dealership, repair station, etc. The warranty data includes vehicle component data. The server 140 can then update the specified range to include vehicle component data associated with the warranty data.

The server 140 is programmed to determine an updated transfer function based on the updated specified range. For example, the server 140 can input the vehicle environment data, the vehicle component data, and the updated specified range of vehicle component parameters to the first machine learning program, as discussed above. In this situation, the first machine learning program outputs an updated transfer function. The updated transfer function correlates the vehicle environment data to vehicle component data within the updated specified range of vehicle component parameters.

The server 140 can generate a component model for each vehicle component 125. A “component model” is a three-dimensional representation that describes the measurements, i.e., dimensions, of the component 125, e.g., lengths, widths, heights, thicknesses, contours or curvatures, etc., as well as other attributes requisite to constructing the component, including and material composition. The component model can be rendered in an engineering drawing such as a computer-aided design (CAD) drawing and/or a computer-aided engineering (CAE) model. For example, the component 125 can be a steering differential that transmits torque from a powertrain to a wheel. In such an example, the component 125 should be optimized to reduce an amount of material to manufacture the component 125 while maintaining material strength to transmit torque over a predetermined time period, e.g., a time specified by a manufacturer warranty, e.g., five years, and/or a predetermined usage, e.g., 60,000 miles. The component model can be stored, e.g., in a memory of the server 140. The server 140 can generate a first component model according to a predetermined set of dimensions for the component 125 and can adjust the size and/or shape of the first component model to another component model.

The server 140 can input the component model and a function, e.g., one of the transfer function, the updated transfer function, or the durability transfer function, to a predictive damage model. The “predictive damage model” is a simulation of stresses on a virtual component 125 represented by the component model, e.g., mechanical stresses, thermal stresses, stresses over time, stresses from movement of portions of the component 125, etc. The predictive damage model can be a CAE model that receives the component model and the function as input and generates data indicating stresses on the virtual component 125 as output. That is, the predictive damage model can be an equation or a set of equations that simulates stresses on the virtual component 125 from inputs such as simulated torque. For example, the output of the predictive damage model can include a “fatigue limit,” i.e., an amount of motion specifying stresses on the virtual component that generate strains exceeding a material yield strength. For example, the fatigue limit of a rotating component 125, e.g., a steering differential, can be a number of revolutions until stresses reach the yield strength at a specified torque. That is, the specified torque can rotate the virtual component 125 and generate stresses. When the stresses induce strains that reach or exceed the yield strength, the predictive damage model can output the number of revolutions at which the yield strength was reached as the fatigue limit.

The server 140 can adjust one or more virtual parameters, e.g., a size, a shape, a weight, a material thickness, etc., of the component model based on the predictive damage model. As described above, the component model describes the size, shape, and material composition of the virtual component 125. The server 140 can, based on the output from the predictive damage model, adjust the component model to adjust output from the predictive damage model. The server 140 can adjust a virtual parameter of the component model based on the output of the predictive damage model. For example, the server 140 can reduce a size of a portion of the component model to generate a new component model to reduce an amount of material required to construct the component 125 and input the adjusted component model to the predictive damage model to generate a fatigue limit for the adjusted component model. In another example, the server 140 can increase a size of the component model to an adjusted component model to reduce strains caused by stresses on the virtual component 125.

The server 140 can adjust the component model until one or more optimization criteria are met. In this context, an “optimization criterion” is a measurable quantity of the virtual component 125 that changes when the server 140 adjusts the component model. Example optimization criteria include, e.g., size, cost, weight, fatigue limit, etc. For example, the server 140 can reduce the size of the component model and input the adjusted component model to the predictive damage model until a weight optimization criterion and a fatigue limit optimization criterion are met. That is, as the server 140 reduces the size of the component model, the weight of a vehicle component 125 constructed according to the component model decreases, and the fatigue limit of the vehicle component 125 decreases. The server 140 can input the function and successive adjusted component models to successive predictive damage models until one or more optimization criteria is satisfied. The server 140 can adjust the size of the component model to reduce the weight of the virtual component 125 while maintain the fatigue limit specified by the optimization criteria. Alternatively, or additionally, the server 140 can adjust a shape and/or a material composition of the component model to meet the optimization criteria. For example, the server 140 can identify a portion of the component model where a stress exceeds a first stress threshold and can increase a material thickness of the portion to decrease the stress to below the first stress threshold. The server 140 can identify a second portion of the component model where a stress is below a second stress threshold and can decrease a material thickness of the second portion to reduce a weight of the second portion. The stress threshold can be, e.g., a yield strength of the material multiplied by a predetermined safety factor, e.g., 0.8. The second stress threshold can be the yield strength of the material multiplied by a minimum stress multiplier, e.g., 0.2.

Upon meeting the optimization criteria, the server 140 can input the adjusted component model into a vehicle dynamics model. The “vehicle dynamics model” is a kinematic model describing vehicle 105 motion that outputs performance data for a virtual component 125 constructed according to the adjusted component model. The vehicle dynamics model includes a model of a plurality of virtual road segments, each road segment representing one or more road conditions associated with an event, as described above. Each road segment includes a specified curvature, slope, and banking, as well as traffic signs, traffic lights, and road markings. Additionally, or alternatively, the vehicle dynamics model can receive the function, and can model performance of the virtual component 125 according to the function. That is, the vehicle dynamics model and output performance of the virtual component 125 according to the vehicle environment data and the vehicle component data received from the plurality of vehicles 105. By inputting a virtual vehicle with the adjusted component model to the vehicle dynamics model, the server 140 can collect data about performance of the virtual component 125 represented by the adjusted component model on road segments corresponding to the events. That is, the server 140 can test the virtual component 125 in a plurality of different (simulated and/or actual) environments and vehicle use scenarios supplemental to the predictive damage model.

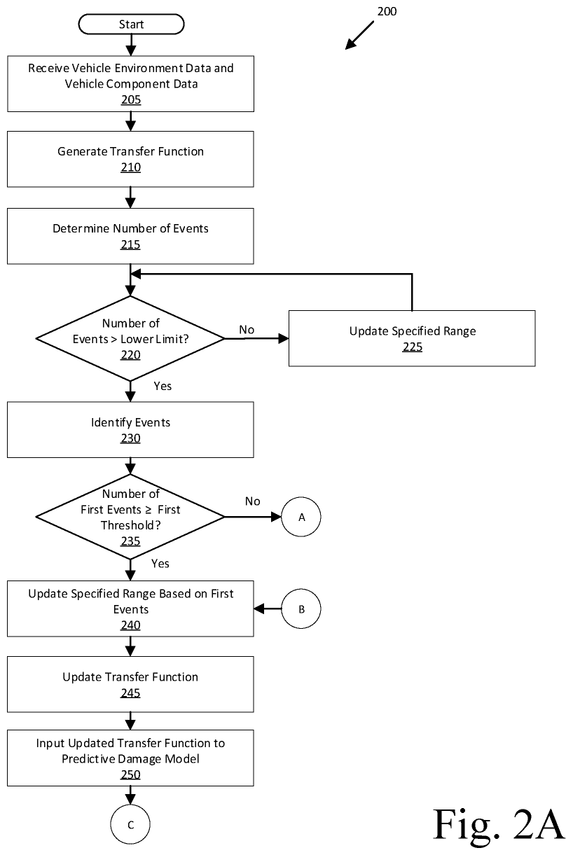

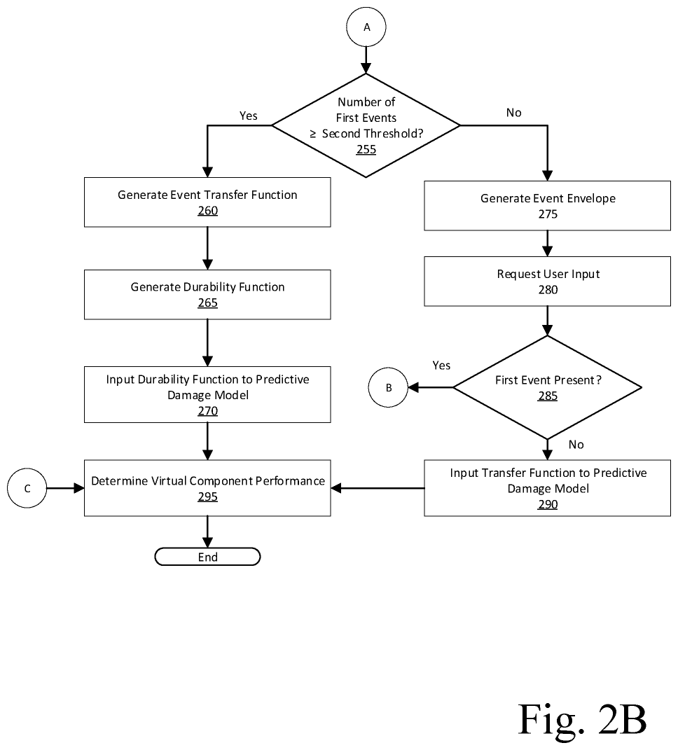

FIG. 2A is a first portion of a flowchart of an example process 200 (the second portion being shown in FIG. 2B because the entire flowchart will not fit on a single drawing sheet) for or designing a vehicle component 125. The process 200 begins in a block 205. The process 200 can be carried out by a server 140 executing program instructions stored in a memory thereof.

In the block 205, the server 140 receives vehicle environment data and vehicle component data from a plurality of vehicles 105, e.g., via a network 135. For example, a vehicle computer 110 in each vehicle 105 can be programmed to obtain the vehicle component data for one or more vehicle components 125. For example, the vehicle computer 110 can receive sensor 115 data from one or more sensors 115 associated with the respective vehicle component 125. The sensor 115 data can include one or more vehicle component parameters. As set forth above, a vehicle component parameter is a measurable quantity of operation of a vehicle component 125.The vehicle computer 110 can then transmit the vehicle component data to the server 140, e.g., via the network 135.

Additionally, the vehicle computer 110 may be programmed to obtain vehicle environment data. As set forth above, vehicle environment data includes road data, weather data, traffic density data, vehicle performance data, and user input data. The vehicle computer 110 can determine the vehicle environment data based on sensor 115 data, as discussed above. The vehicle computer 110 can then transmit the vehicle environment data to the remote server computer 140, e.g., via the network 135. The process 200 continues in a block 210.

In the block 210, the server 140 generates a transfer function that correlates the vehicle environment data to the vehicle component data within a specified range. As set forth above, the specified range is a range defined by minimum and maximum values of vehicle component parameters that corresponds to normal vehicle component operation. The server 140 can, for example, input the vehicle environment data, the vehicle component data, and the specified range into a first machine learning program that outputs the transfer function, as discussed above. The process 200 continues in a block 215.

In the block 215, the server 140 determines a total number of events for a vehicle component. As set forth above, an event is a set of characteristics about a road that includes a road attribute and a vehicle use attribute on the road. The server 140 can determine the total number of events by counting each datum of vehicle component data that is outside of the specified range. The process 200 continues in a block 220.

In the block 220, the server 140 determines whether the total number of events is greater than or equal to a lower limit (as discussed above). For example, the server 140 can compare the total number of events to the lower limit. When the total number of events is greater than or equal to the lower limit, the process 200 continues in a block 230. Otherwise the process 200 continues in a block 225.

In the block 225, the server 140 updates the specified range. For example, the server 140 can decrease the specified range by a predetermined percentage (as discussed above). The process 200 returns to the block 220.

In the block 230, the server 140 identifies each event based on each datum that is outside the specified range. For example, the server 140 can input each datum that is outside the specified range and the vehicle environment data associated with each datum into another machine learning program that outputs an identified event for each datum. As set forth above, the machine learning program can identify a plurality of events based on the data. The process 200 continues in a block 235.

In the block 235, the server 140 determines whether a number of identified (e.g., first) events is greater than or equal to a first threshold (as discussed above). For example, upon identifying a first event, the server 140 can increase the number of first events by one. The server 140 can then compare the number of first events to the first threshold. When the number of first events is greater than or equal to the first threshold, the process 200 continues in a block 240. Otherwise, the process 200 continues in a block 255.

In the block 240, the server 140 updates the specified range based on the first event. For example, the server 140 can increase the specified range, e.g., by decreasing the minimum value and/or increasing the maximum value of the vehicle component parameter, to include the vehicle component data associated with the first event. The process 200 continues in a block 245.

In the block 245, the server 140 updates the transfer function based on the updated specified range. For example, the server 140 can input the vehicle environment data, the vehicle component data, and the updated specified range to the first machine learning program. The first machine learning program can then output an updated transfer function that correlates the vehicle environment data to vehicle component data within the updated specified range. The process 200 continues in a block 250.

In the block 250, the server 140 inputs the updated transfer function to a predictive damage model. Additionally, the server 140 can generate a component model for each vehicle component 125 and can input the component model to the predictive damage model. The server 140 can adjust one or more virtual parameters of the component model based on the output from the predictive damage model, as discussed above. The server 140 can continuing adjusting the component model until one or more optimization criteria (as discussed above) are met by inputting the updated transfer function and successive adjusted component models to successive predictive damage models until one or more optimization criteria is satisfied. The process 200 continues in a block 295.

Turning now to FIG. 2B, following the block 250 shown in FIG. 2A, in the block 255, the server 140 determines whether the number of first events is greater than or equal to a second threshold (as discussed above). When the number of first events is greater than or equal to the second threshold, the process 200 continues in a block 260. Otherwise, the process 200 continues in a block 275.

In the block 260, the server 140 generates an event transfer function based on the first event. The event transfer function correlates the first event to datum for each first event within an event range. As set forth above, the event range is a range defined by minimum and maximum values of data of vehicle component parameters associated with the first event. The server 140 can input the first event and the datum for each first event to a second machine learning program that outputs the event transfer function. The second machine learning program can be substantially similar to the first machine learning program, as discussed above. The process 200 continues in a block 265.

In the block 265, the server 140 generates a durability transfer function based on the event function and the transfer function. The durability transfer function correlates the vehicle environment data to the vehicle component data within a durability range. For example, the server 140 can combine, e.g., add, the event transfer function and the transfer function, as discussed above. Additionally, the server 140 determines the durability range by combining, e.g., adding, the specified range and the event range. The process 200 continues in the block 270.

In the block 270, the server 140 inputs the durability transfer function to a predictive damage model. Additionally, the server 140 can generate a component model for each vehicle component 125 and can input the component model to the predictive damage model. The server 140 can adjust one or more virtual parameters of the component model based on the output from the predictive damage model, as discussed above. The server 140 can continuing adjusting the component model until one or more optimization criteria (as discussed above) are met by inputting the durability transfer function and successive adjusted component models to successive predictive damage models until one or more optimization criteria is satisfied. The process 200 continues in the block 295.

In the block 275, the server 140 generates an event envelope for each first event. As set forth above, an event envelope is a plot of vehicle environment data and vehicle component data over time. The server 140 can input vehicle environment data and vehicle component data collected within a time period (as discussed above) to the event envelope. The process 200 continues in a block 280.

In the block 280, the server 140 can request a user input specifying an absence or a presence of the first event. For example, the server 140 can transmit the request and the event envelope to a user computer 145, e.g., via the network 135. The user computer 145 can include an HMI to detect user inputs and provide user input data to the user computer 145. The user computer 145 can determine the selection of the user input based on the user input data. The user computer 145 can then transmit the selection of the user input to the server 140, e.g., via the network 135.

In the block 285, the server 140 determines whether the first event is present. For example, the server 140 can receive the user selection from the user computer 145, as discussed in block 280. In the case that the user selection specifies the presence of the first event, the server 140 can determine the first event is present. In the case that the user selection specifies the absence of the first event, the server 140 can determine the first event is not present.

Additionally, or alternatively, the server 140 can receive health data for the vehicle component 125, e.g., from the user computer 145 or another computer. As discussed above, the health data can include a DTC and/or warranty data associated with the vehicle component 125. The server 140 can then compare the health data to the first event. In the case that the health data correlates to the first event, the server 140 can determine the first event is present. In the case that the health data does not correlates to the first event, the server 140 can determine the first event is not present. When the first event is present, the process 200 continues in returns to the block 240. Otherwise the process 200 continues in a block 290.

In the block 290, the server 140 inputs the transfer function to a predictive damage model. Additionally, the server 140 can generate a component model for each vehicle component 125 and can input the component model to the predictive damage model. The server 140 can adjust one or more virtual parameters of the component model based on the output from the predictive damage model, as discussed above. The server 140 can continuing adjusting the component model until one or more optimization criteria (as discussed above) are met by inputting the transfer function and successive adjusted component models to successive predictive damage models until one or more optimization criteria is satisfied. The process 200 continues in a block 295.

In the block 295, the server 140 determines performance of a virtual component constructed according to the adjusted component model. For example, the server 140 can input the adjusted component model into a vehicle dynamics model (as discussed above) that outputs performance data for a virtual component 125. By inputting the virtual component 125 to the vehicle dynamics model, the server 140 can test the virtual component 125 in a plurality of different (simulated and/or actual) environments and vehicle use scenarios supplemental to the predictive damage model. The process 200 ends following the block 295.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

What is claimed is:

1. A system, comprising a computer including a processor and a memory, the memory storing instructions executable by the processor to:
input vehicle environment data about operation of a plurality of vehicles and vehicle component data for a vehicle component into a machine learning program to obtain a transfer function that correlates vehicle environment data to vehicle component data within a specified range of vehicle component parameters;
identify a first event based on determining that a datum in the vehicle component data is outside the specified range;
update a predictive damage model of a vehicle component based on the first event; and
adjust a virtual parameter of a component model based on output from the predictive damage model.

2. The system of claim 1, wherein the instructions further include instructions to:
upon determining a number of first events for the plurality of vehicles equals a threshold, input the first event and the datum for each first event to a second machine learning program;
output from the second machine learning program an event transfer function that correlates the first event to the data of the first events;
determine a durability transfer function by combining the transfer function and the event transfer function; and
update the predictive damage model based on the durability transfer function.

3. The system of claim 2, wherein the instructions further include instructions to update the specified range to include the datum for each first event.

4. The system of claim 1, wherein the instructions further include instructions to, upon determining a number of first events is below a threshold, request a user input specifying a presence or absence of the first event.

5. The system of claim 4, wherein the instructions further include instructions to, upon receiving the user input specifying the presence of the first event, update the specified range to include the datum.

6. The system of claim 4, wherein the instructions further include instructions to generate an event envelope including the datum of the vehicle component data and provide the event envelope to a user computer.

7. The system of claim 1, wherein the instructions further include instructions to, upon determining a number of first events is above a threshold, update the specified range to include the datum.

8. The system of claim 1, wherein the instructions further include instructions to decrease the specified range based on a number of first events being less than or equal to a lower limit.

9. The system of claim 1, wherein the instructions further include instructions to, upon adjusting the virtual parameter of the component model, update a predictive damage model of an adjusted component model based on the first event and adjust a virtual component of the adjusted component model based on the output of the predictive damage model of the adjusted component model.

10. The system of claim 9, wherein the instructions further include instructions to update successive predictive damage models of successive adjusted component models based on the first event until an optimization criterion for the virtual parameter is satisfied.

11. The system of claim 9, wherein the instructions further include instructions to input the adjusted component model into a vehicle dynamics model that outputs performance data for the virtual component constructed in accordance with the adjusted component model.

12. The system of claim 11, wherein the vehicle dynamics model includes a model of a plurality of road segments and the performance data includes data of the virtual component operating in each segment.

13. The system of claim 11, wherein the vehicle dynamics model includes a model of a plurality of environmental conditions, and the performance data includes data of the virtual component operating in the plurality of environmental conditions.

14. The system of claim 1, wherein the instructions further include instructions to, upon detecting a diagnostic trouble code associated with the vehicle component, correlate the first event to the diagnostic trouble code, and update the specified range to include the datum.

15. The system of claim 1, wherein the instructions further include instructions to, upon determining a number of first events is zero after a predetermined time, increase the specified range.

16. The system of claim 1, wherein the output of the predictive damage model generates data indicating stresses the virtual component.

17. The system of claim 1, wherein the vehicle environment data includes road data, weather data, traffic density data, vehicle performance data, and user input data.

18. A method, comprising:
inputting vehicle environment data about operation of a plurality of vehicles and vehicle component data for a vehicle component into a machine learning program to obtain a transfer function that correlates vehicle environment data to vehicle component data within a specified range of vehicle component parameters;
identifying a first event based on determining that a datum in the vehicle component data is outside the specified range;
updating a predictive damage model of a vehicle component based on the first event; and
adjusting a virtual parameter of a component model based on output from the predictive damage model.

19. The method of claim 18, further comprising:
upon determining a number of first events for the plurality of vehicles equals a threshold, inputting the first event and the datum for each first event to a second machine learning program;
outputting from the second machine learning program an event transfer function that correlates the first event to the data of the first events;
determining a durability transfer function by combining the transfer function and the event transfer function; and
updating the predictive damage model based on the durability transfer function.

20. The method of claim 18, further comprising, upon adjusting the virtual parameter of the component model, updating a predictive damage model of an adjusted component model based on the first event and adjusting a virtual component of the adjusted component model based on the output of the predictive damage model of the adjusted component model.
